(19) United States
(12) Patent Application Publication
(10) Pub. No.: US 2013/0224991 A1
(43) Pub. Date: Aug. 29, 2013

(54) STRUCTURE OF ELECTRICAL SIGNAL SWITCH CONNECTOR

(71) Applicant: Speed Tech Corp., (US)

(72) Inventors: Hsing-Yu LEE, TAOYUAN HSIEN (TW); Cheng-Hsiang HSUEH, TAOYUAN HSIEN (TW)

(73) Assignee: SPEED TECH CORP., TAOYUAN HSIEN (TW)

(21) Appl. No.: 13/772,350

(22) Filed: Feb. 21, 2013

(30) Foreign Application Priority Data
Feb. 22, 2012 (TW) 101202986

(51) Int. Cl. H01R 13/52

(52) U.S. Cl. CPC H01R 13/52
USPC 439/519

(57) ABSTRACT

A structure of an electrical signal switch connector is provided, which includes an insulating housing, an elastic terminal, a fixing terminal and a shielding housing. The insulating housing is configured for receiving the elastic terminal and the fixing terminal respectively. The elastic terminal has an elastic arm with an opening. The fixing terminal has a fixing arm. The elastic arm of the elastic terminal elastically abuts against the fixing arm of the fixing terminal. A penetration hole of the insulating housing is configured for penetrating a terminal of a docking connector. The shielding housing covers on a surface of the insulating housing, such that the foreign substances in the environment are kept from attaching to the elastic arm of the elastic terminal.

### RELATED APPLICATIONS

This application claims priority to TW application Serial Number 101202986, filed Feb. 22, 2012, which is herein incorporated by reference.

### BACKGROUND

1. Technical Field

The present disclosure relates to a structure of an electrical signal switch connector. More particularly, the present disclosure relates to a structure of an electrical signal switch connector capable of switching a transmitting path of a high frequency electrical signal.

2. Description of Related Art

Generally, a functional testing may be performed for each part of an overall unit after a whole assembly of an electrical device is completed. This testing has to be conducted effectively during a short period as fully as possible in detecting functions of each part of the electrical device. Further, a signal switch is used to change the transmitting path of the electrical signal during the testing, so as to examine whether the circuit of each part of the electrical device may arrive an expected function. For a high frequency electrical device, for example, a mobile phone, though this testing for the overall unit may be performed in a random sampling manner, in order to decrease a distortion of the testing and simplify the testing process, at least one high frequency electrical signal coaxial switch is mounted in all these electrical devices, such that the non-sampled samples may be inferred. The related information of this high frequency electrical signal coaxial switch is disclosed in such as the U.S. Pat. No. 6,808,405, U.S. Pat. No. 7,217,737, and Taiwan Invention Patent Publication No. TW201036284.

As shown in FIGS. 7 and 8, a coaxial connector with a switch and an assembly method thereof are disclosed in Taiwan Invention Patent Publication No. TW201036284. The connector is configured for receiving an elastic terminal B and a fixing terminal C by an insulating housing A. The elastic terminal. B and the fixing terminal. C are maintained on a stable position on the insulating housing A. A shielding housing U is covered outside the insulating housing A. The shield housing D is configured for providing a good electromagnetic shielding protection for the insulating housing A to decrease an interference caused by a mutual induction between the electromagnetic fields inside and outside the insulating housing A.

The elastic terminal B has a body part B1. An elastic arm B2 and a welding part B3 are extended from both ends of the body part B1 of the elastic terminal B respectively, and the elastic arm B2 of the elastic terminal B is a metal cantilever with elasticity. The fixing terminal C also has a body part C1. A fixing arm C2 and a welding part C3 are extended from both ends of the body part C1 of the fixing terminal C respectively. The insulating housing A has an elastic terminal chamber A1 and a fixing terminal chamber A2. The elastic terminal chamber A1 of the insulating housing A may be configured for receiving the body part B1 of the elastic terminal B, and the fixing terminal chamber A3 of the insulating housing A may be configured for receiving the body part C1 of the fixing terminal C, such that the elastic terminal B and the fixing terminal C may be fixed to a location inside the insulating housing A. The welding part B3 of the elastic terminal B and the welding part C3 of the fixing terminal C are extended outward from the insulating housing A to a circuit board (not shown), such that the welding part B3 of the elastic terminal. B and the welding part C3 of the fixing terminal C may be electrically connected with different contacts on the circuit board, respectively.

The elastic arm B2 of the elastic terminal B normally abuts against a lower edge of the fixing arm C2 of the fixing terminal C, such that the elastic terminal B and the fixing terminal C are normally electrically connected. The insulating housing A is opened with a penetration hole A3. The penetration hole A3 of the insulating housing A is configured for receiving a docking connector or a probe for testing (both of them not shown) of the testing device to penetrate into, such that the docking connector may enter the penetration hole A3 of the insulating housing A and press down the elastic arm B2 of the elastic terminal B, and damage a normal electrical connection state between the elastic terminal B and the fixing terminal C.

Since the coaxial switch connector typically has a very small bulk volume and is generally configured for transmitting the high frequency electrical signal, once the foreign substances in a production or a testing environment invade into the connector, it is very possibly for the foreign substances to affect the transmission of the high frequency electrical signal. The foreign substances (not shown) invading into the connector may result from solders, plastic dusts or metal chips for a welding terminal. These foreign substances are likely to cause the elastic terminal B which cannot be electrically disconnected with the fixing terminal C or cause both of them which are normally disconnected, resulting in the coaxial switch failure. As shown in FIGS. 7 and 8, in order to prevent the foreign substance from invading into the connector, the prior art teaches that, a press part A4 is extended from a suitable position of the insulating housing A and when the shielding housing D is assembled outside the insulating housing A, a notch D1 is formed on a surface of the shielding housing D such that the notch D1 of the shielding housing D may be configured for forcing the press part A4 of the insulating housing A to generate a deformation, so as to seal up a gap between the elastic terminal B and the elastic terminal chamber A1 to disenable the environmental foreign substances to attach to the elastic arm B2 of the elastic terminal B.

The prior art seals up the gap between the insulating housing A and the elastic terminal B to prevent the foreign substances of the environment from invading into the connector. However, the prior art not only ignores a possibility that the foreign substances are more likely to invade into the insulating housing A from the penetration hole A3 of the insulating housing A, but also it ignores that once the press part A4 of the insulating housing A is broken off, it is possible for the elastic terminal B to contact with the shielding housing D unexpectedly. Therefore, a need exists the prior art to address the aforementioned deficiencies and inadequacies.

### SUMMARY

The present disclosure primarily aims to provide a structure of an electrical signal switch connector. The connector is configured for preventing foreign substances in the environment from attaching to a terminal and invading into the connector.

The present disclosure is to provide a structure of an electrical signal switch connector, which includes an insulating housing, an elastic terminal, a fixing terminal and a shielding housing. The insulating housing is preferably formed of non-conductive material for fixing the elastic terminal and the fixing terminal preferably made of metal material. The elastic terminal has an elastic arm, and the fixing terminal has a fixing arm. The elastic arm of the elastic terminal elastically abuts against the fixing arm of the fixing terminal, such that the elastic terminal and the fixing terminal maintain a normal electrical connection. The insulating housing has a penetration hole. The penetration hole of the insulating housing is configured for penetrating a docking electrical device (the docking electrical device generally being penetrated into the penetration hole of the insulating housing with a metal terminal). The elastic arm of the elastic terminal has an opening. As such, the foreign substances of the environment falling into the connector from the penetration hole of the insulating housing are kept from attaching to the elastic arm of the elastic terminal by way of the opening.

### BRIEF DESCRIPTION OF THE DRAWINGS

FIG. 1 is a perspective appearance diagram according to the first embodiment of the present disclosure;

FIG. 2 is a schematic diagram of Fig.;

FIG. 3 is an another schematic diagram of FIG. 1;

FIG. 4 is a perspective exploded diagram of FIG. 1;

FIG. 4-1 is a schematic diagram of an organizational form of the terminal in FIG. 4;

FIG. 4-2 is a schematic diagram of an organizational form of the terminal in the second embodiment of the present disclosure;

FIG. 5 is a front diagram of the present disclosure;

FIG. 6 is a sectional diagram along AA in FIG. 5;

FIG. 7 is a perspective appearance diagram of the prior art; and

FIG. 8 is a sectional diagram of the prior art.

### DETAILED DESCRIPTION

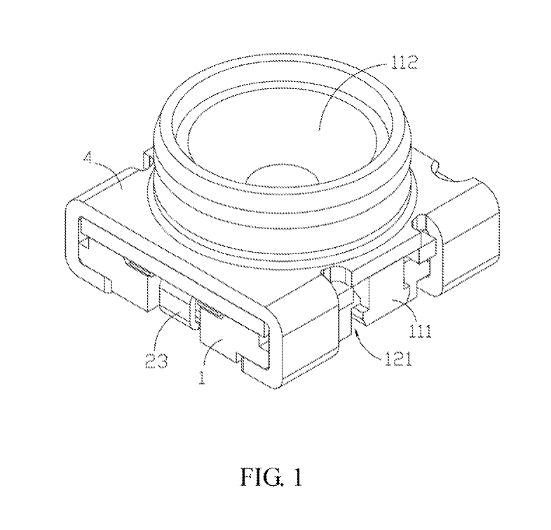

As shown in FIGS. 1 to 4, a first embodiment of the present disclosure is primarily made up of an insulating housing 1, an elastic terminal 2, a fixing terminal 3 and a shielding housing 4. The insulating housing 1 includes an upper cover 11, a base 12 and a connection part 13 that are formed as a whole. The connection part 13 is connected between the upper cover 11 and the base 12 of the insulating housing 1. The upper cover 11 of the insulating housing 1 has a convex button 111. Corresponding to the convex button 111 of the upper cover 11 of the insulating housing 1, a slot 121 is disposed at an edge of the base 12 of the insulating housing 1, such that the upper cover 11 of the insulating housing 1 may utilize the connection part 13 serving as a hinge to be covered on the base 12 of the insulating housing 1 and utilize a mutual coordination between the convex button 111 of the upper cover 11 and the slot 121 of the base 12 to fix the upper cover 11 onto the base 12.

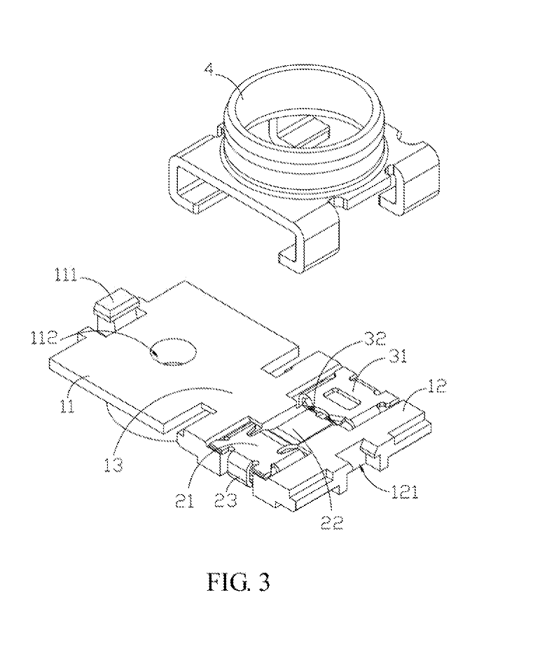

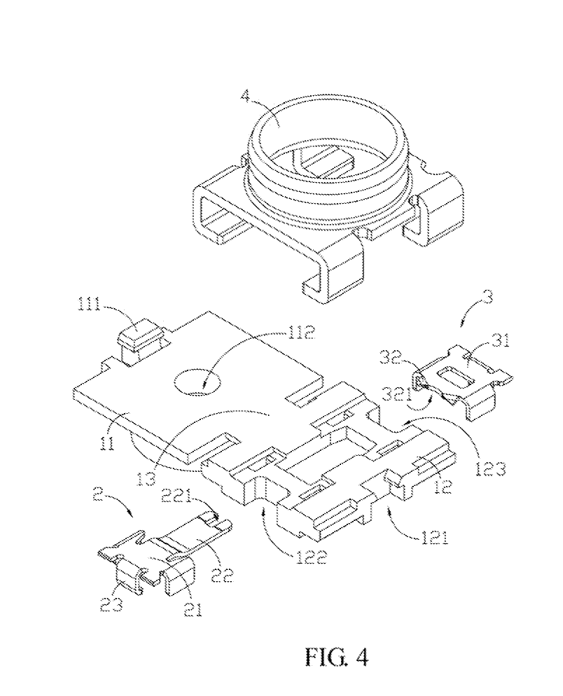

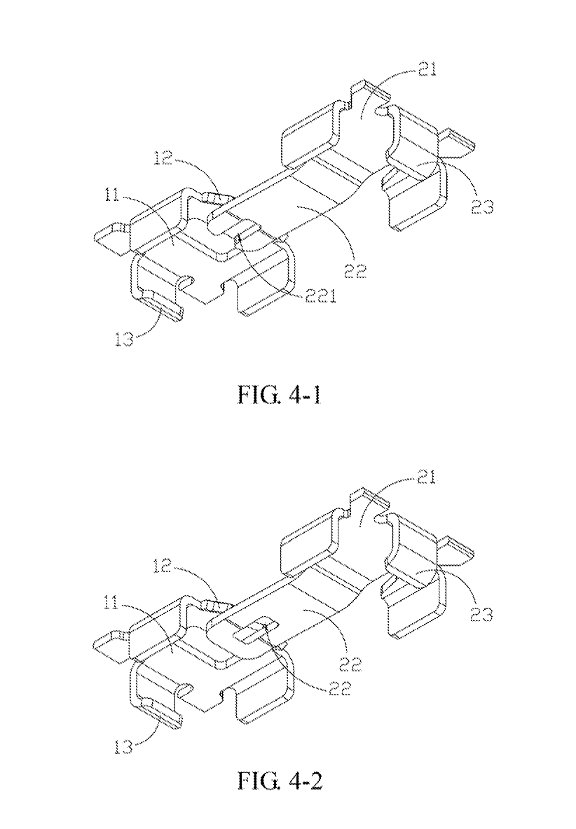

As shown in FIGS. 3 and 4, the upper cover 11 of the insulating housing 1 has a penetration hole 112. The penetration hole 112 of the upper cover 11 may enter the insulating housing 1 with a connector for testing or a probe, so as to contact with the elastic terminal 2 and exchange an electrical signal with the elastic terminal 2. The base 12 of the insulating housing 1 has an elastic terminal chamber 122 and a fixing terminal chamber 123 thereon. The elastic terminal chamber 122 and the fixing terminal chamber 123 on the base 12 are respectively configured for receiving the elastic terminal 2 and the fixing terminal 3, such that at least a portion of the elastic terminal 2 and the fixing terminal 3 is retained stably in the insulating housing 1. The elastic terminal 2 has a body part 21. An elastic arm 22 and a welding part 23 are respectively extended from end edges of the body part 21 of the elastic terminal 2. The body part 21 of the elastic terminal 2 is received in the elastic terminal chamber 122 of the base 12 of the insulating housing 1. The elastic arm 22 of the elastic terminal 2 is a long cantilever extended from the body part 21 of the elastic terminal 2, such that the elastic arm 22 of the elastic terminal 2 may generate an elastic deformation quantity with a certain amplitude when withstanding an external force. The welding part 23 of the elastic terminal 2 is extended outside the insulating housing 1, such that the elastic terminal 2 may be electrically connected with a circuit board (not shown) outside the insulating housing 1 by the welding part 23. The fixing terminal 3 also has a body part 31. A fixing arm 32 and a welding part 33 are respectively extended from end edges of the body part 31 of the fixing terminal 3. The body part 31 of the fixing terminal 3 is received in the fixing terminal chamber 123 of the base 12 of the insulating housing 1. The fixing arm 32 of the fixing terminal 3 is a short cantilever extended from the body part 31 of the fixing terminal 3, such that the fixing arm 32 of the fixing terminal 3 may generate an elastic deformation quantity with a relatively small amplitude when withstanding an external force. The welding part 33 of the fixing terminal 3 is extended outside the insulating housing 1, such that the fixing terminal 3 may be electrically connected with the circuit board (not shown) outside the insulating housing 1 by the welding part 33.

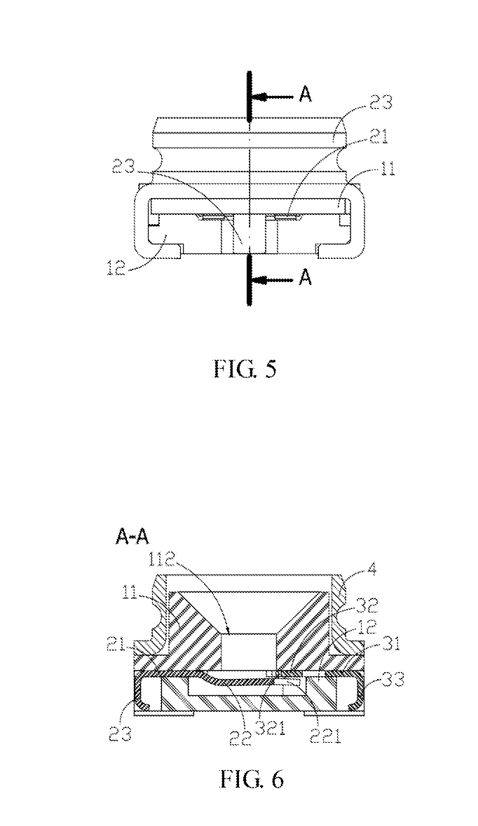

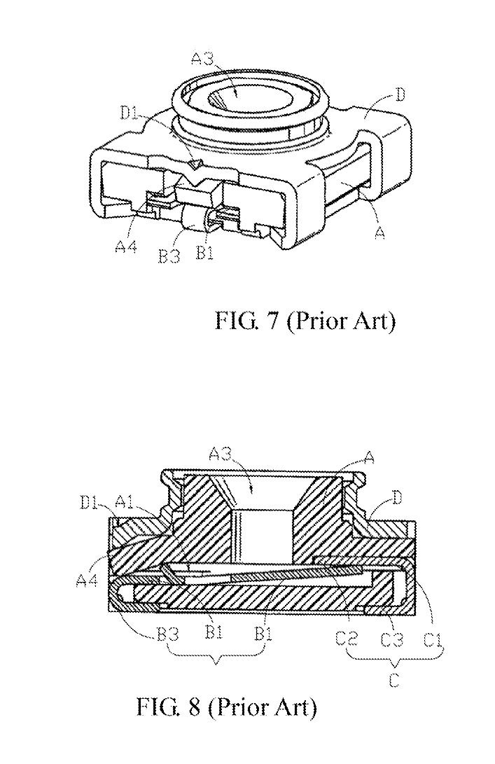

As shown in FIGS. 3, 4, 5 and 6, a free end of the elastic arm 22 of the elastic terminal 2 abuts against a lower edge of the fixing arm 32 of the fixing terminal 3, such that the elastic terminal 3 and the fixing terminal 2 are normally electrically connected. The free end of the elastic arm 22 of the elastic terminal 2 is opened with an opening 221, such that the opening 221 of the elastic terminal 2 may extend a distance from the free end of the elastic arm 22 of the elastic terminal 2 towards the body part 21, and the free end of the fixing arm 32 of the fixing terminal 3 has an embossment 321, such that a gap is formed between the free ends of the elastic arm 22 of the elastic terminal 2 and the fixing arm 32 of the fixing terminal 3 to lessen a contact area between the free ends. When the foreign substances fall into the connector from the penetration hole 112 of the insulating housing 1, the foreign substances may fall from the gap between the elastic arm 22 and the fixing arm 32 or the opening 221 of the elastic arm 22, and the electrical connection state between the elastic terminal 2 and the fixing terminal 3 may also be maintained at the same time.

As shown in FIGS. 4, 41 and 6, since the body part 21 of the elastic terminal 2 is assembled to the elastic terminal chamber 122 of the insulating housing 1 the insulating housing 1 has the obvious terminal chamber 122. If the body part 21 of the elastic terminal 2 is configured for directly forming the plastic material on the surface of the body part 21 of the elastic terminal 2 in an insert molding manner and the like, at the moment, the insulating housing 1 may not have the obvious terminal chamber 122. Though the insert molding manner is configured for covering the body part 21 of the elastic terminal 2 with the plastic material of the insulating housing 1, when the plastic material of the insulating housing 1 is removed by a plastic deformation technique and the body part 21 of the elastic terminal 2 is taken out, the insulating housing 1 will still show a space capable of receiving the body part 21 of the elastic terminal 2. According to the above description, the “elastic terminal chamber” 122 of the insulating housing referred to in the present disclosure and the claims refers to the space on the insulating housing 1 capable of receiving the body part 21 of the elastic terminal 2. In the same way, the “fixing terminal chamber” 123 of the insulating housing 1 referred to in the present disclosure and the claims refers to the space on the insulating housing 1 capable of receiving the body part 31 of the fixing terminal 3.

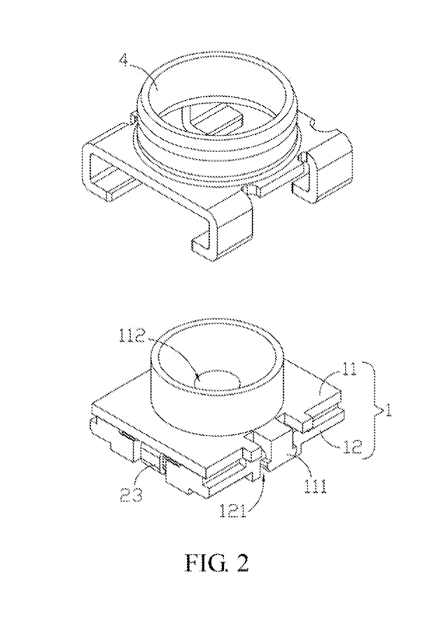

As shown in FIG. 4-2, in the embodiment of the present disclosure, an end of the elastic arm 22 of the elastic terminal 2 has an opening 221, and the position of the opening 221 of the elastic terminal 2 is at a distance from the free end of the elastic arm 22 of the elastic terminal 2. Though the opening 221 of the elastic terminal 2 is at a distance from the free end of the elastic arm 22 of the elastic terminal 2, the opening 221 still has the function of excluding the foreign substances. Even if the volume of the foreign substances is too large to be excluded from the opening 221 of the elastic terminal 2, during a testing process, when the docking connector or the probe for testing (both of them not shown) presses down the elastic arm 22 of the elastic terminal 2, the foreign substances may also slide off along the elastic arm 22 of the elastic terminal 2.

Though the present disclosure has been disclosed above with preferred embodiments, these embodiments are not intended to limit the scope of the present disclosure. It will be apparent to those of skills in the art that some variations and modifications can be made without departing from the spirit and scope of the present disclosure. Therefore, the scope of the present disclosure shall be defined by the appended claims.

What is claimed is:

1. A structure of an electrical signal switch connector, comprising
an insulating housing having an elastic terminal chamber, a fixing terminal chamber, and a penetration hole;
an elastic terminal having an elastic arm;
a fixing terminal having a fixing arm; and
a shielding housing,
wherein the elastic terminal chamber and the fixing terminal chamber of the insulating housing are respectively configured for receiving the elastic terminal and the fixing terminal; the elastic arm of the elastic terminal elastically abuts against the fixing arm of the fixing terminal; the elastic terminal and the fixing terminal have a welding part respectively, and the welding parts of the elastic terminal and the fixing terminal are respectively extended outside the insulating housing; the penetration hole of the insulating housing is configured for penetrating a terminal of a docking connector; and the shielding housing covers a surface of the insulating housing, and wherein the elastic arm of the elastic terminal has an opening.

2. The structure of the electrical signal switch connector of claim 1, wherein the opening of the elastic terminal extends from a free end of the elastic arm.

3. The structure of the electrical signal switch connector of claim 1, wherein the insulating housing has an upper cover and a base, the upper cover and the base are mutually connected by a connection part, and the upper cover of the insulating housing covers on the base by the connection part as a hinge.

4. The structure of the electrical signal switch connector of claim 3, wherein the penetration hole of the insulating housing is disposed to the upper cover of the insulating housing, and the elastic terminal chamber and the fixing terminal chamber of the insulating housing are disposed to the base of the insulating housing.

5. The structure of the electrical signal switch connector of claim 3, wherein a convex button is disposed to the upper cover of the insulating housing away from the connection part, corresponding to the convex button of the upper cover of the insulating housing; a slot is disposed to the base of the insulating housing; and a relative position between the upper cover of the insulating housing and the base is aligned by a coordination between the convex button of the upper cover of the insulating housing and the slot of the base.

6. The structure of the electrical signal switch connector of claim 1, wherein the elastic terminal has a body part which is configured for connecting the elastic arm and the welding part of the elastic terminal, and the fixing terminal also has a body part which is configured for connecting the fixing arm and the welding part of the fixing terminal.

7. The structure of the electrical signal switch connector of claim 1, wherein the opening of the elastic terminal is located below the fixing arm of the fixing terminal.

8. The structure of the electrical signal switch connector of claim 1, wherein a free end of the fixing arm of the fixing terminal has an embossment, such that a smaller contact area is provided between the elastic arm of the elastic terminal and the fixing arm of the fixing terminal.
